(19) United States
(12) Patent Application Publication
(10) Pub. No.: US 2021/0382588 A1
(43) Pub. Date: Dec. 9, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Katsutoshi SAKAGUCHI, Kanagawa (JP)

(73) Assignee: FUJIFILM Business Innovation Corp., Tokyo (JP)

(21) Appl. No.: 17/111,522

(22) Filed: Dec. 4, 2020

(30) Foreign Application Priority Data
Jun. 4, 2020 (JP) 2020-097399

(51) Int. Cl. G06F 3/0482; G06F 3/0484; G06F 3/0485

(52) U.S. Cl. CPC G06F 3/0482; G06F 3/0488; G06F 3/04855; G06F 3/04845

(57) ABSTRACT

An information processing apparatus includes a memory, and a processor configured to display a first, selectable image at first position on a display, display a second image over at least part of the first image so as to hide the at least part of the first image, and, when the second image is displayed over the at least part of the first image, exert control so as to receive an operation for making the first image visible and selectable while continuing to display the second image at the first position.

### CROSS-REFERENCE TO RELATED APPLICATIONS

This application is based on and claims priority under 35 USC 119 from Japanese Patent Application No. 2020-097399 filed Jun. 4, 2020.

### BACKGROUND

### (i) Technical Field

The present disclosure relates to an information processing apparatus and a non-transitory computer readable medium.

### (ii) Related Art

Japanese Unexamined Patent Application Publication No. 2018-045421 discloses an image forming apparatus in which, when a second image such as a banner is superimposed on at least a part of a first image such as an icon, the display position of at least one of the images, the first image and the second image, is changed. Thus, the image forming apparatus achieves suppression of the state in which a user, who is going to select the second image, selects the first image erroneously.

### SUMMARY

Aspects of non-limiting embodiments of the present disclosure relate to an information processing apparatus and a non-transitory computer readable medium. Even when a second image is displayed so as to be superimposed on the display area, in which a first image which is selectable is displayed, the information processing apparatus and the non-transitory computer readable medium may receive an operation of causing the first image to be recognized visually with the second image being displayed, and to be selected.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory, and a processor configured to display a first, selectable image at first position on a display, and to display a second image over at least part of the first image so as to hide the at least part of the first image is invisible. When the second image is displayed over the at least part of the first image, the processor is configured to exert control so as to receive an operation for making the first image visible and selectable while continuing to display the second image at the first position.

### BRIEF DESCRIPTION OF THE DRAWINGS

Exemplary embodiment of the present disclosure will be described in detail based on the following figures, wherein:

FIG. 1 is a diagram illustrating the system configuration of an information processing system according to an exemplary embodiment of the present disclosure;

FIG. 2 is a block diagram illustrating the hardware configuration of a mobile terminal according to an exemplary embodiment of the present disclosure;

FIG. 3 is a block diagram illustrating the functional configuration of a mobile terminal according to an exemplary embodiment of the present disclosure;

FIG. 4 is a diagram illustrating an exemplary operation screen displayed on a display screen of a mobile terminal;

FIG. 5 is a diagram illustrating an example in which a banner image is displayed on the operation screen illustrated in FIG. 4;

FIG. 6 is a diagram illustrating the state in which, when a banner image is displayed so as to cover operation buttons, a user taps the operation screen for scrolling;

FIG. 7 is a diagram illustrating the state in which, when a banner image is displayed so as to cover operation buttons, a user taps the operation screen for scrolling;

FIG. 8 is a diagram illustrating the state in which operation buttons have been moved through a user's operation to a position at which a banner image is not superimposed on the operation buttons;

FIG. 9 is a diagram illustrating an exemplary operation screen having the scroll function;

FIG. 10 is a diagram for describing the relationship between the scroll range and the display area in scroll display;

FIG. 11 is a diagram illustrating an exemplary case in which a banner image is displayed on an operation screen having the scroll display function;

FIG. 12 is a flowchart for describing operations of a controller which displays a banner image so that the banner image is superimposed on an operation screen having the scroll function;

FIG. 13 is a diagram illustrating the scroll range in the state without a superimposed banner image;

FIG. 14 is a diagram illustrating the scroll range in the state with a superimposed banner image;

FIG. 15 is a diagram illustrating an exemplary operation screen on a mobile terminal for which the scroll range has been changed;

FIG. 16 is a diagram illustrating the state in which a user touches an operation screen to scroll down and in which an operation screen is accordingly moved further;

FIG. 17 is a diagram illustrating the state in which operation buttons have been moved to a position at which a banner image is not superimposed on the operation buttons;

FIG. 18 is a diagram for describing an exemplary operation performed when the hold state enables a scroll operation;

FIG. 19 is a diagram for describing an exemplary operation performed when the hold state enables a scroll operation;

FIG. 20 is a diagram illustrating an exemplary operation screen displayed when there is dependence between display elements;

FIG. 21 is a diagram illustrating the state in which a change button is hidden due to display of a banner image;

FIG. 22 is a diagram illustrating the state in which a preset button is outside the display area and is not displayed due to a scroll operation for moving a change button;

FIG. 23 is a diagram illustrating an exemplary operation screen displayed when the display elements on an operation screen are reduced in size; and

FIG. 24 is a diagram illustrating an exemplary operation screen displayed when the display position of a preset button is changed.

### DETAILED DESCRIPTION

An exemplary embodiment of the present disclosure will be described in detail below by referring to the drawings.

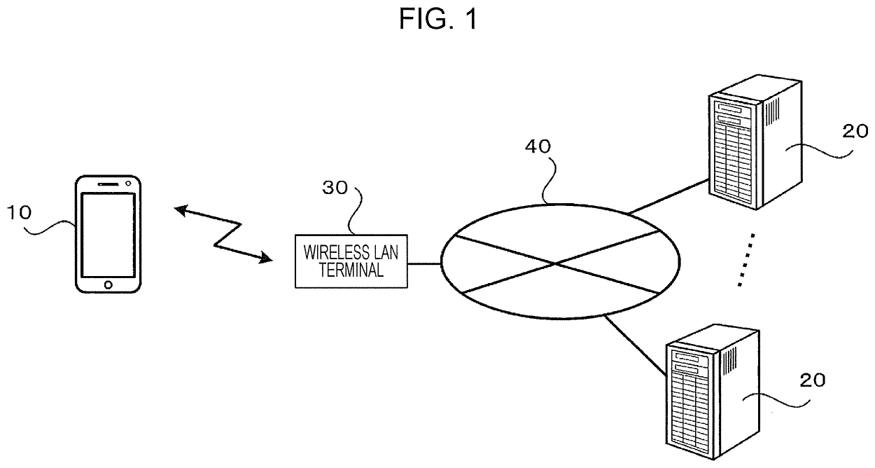

FIG. 1 is a diagram illustrating the system configuration of an information processing system according to an exemplary embodiment of the present disclosure.

As illustrated in FIG. 1, the information processing system according to an exemplary embodiment of the present disclosure includes a mobile terminal 10 and server apparatuses 20 which provide various services. The mobile terminal 10 is connected to the server apparatuses 20 through a wireless local-area network (LAN) terminal 30 and the Internet 40. The mobile terminal 10 according to the present exemplary embodiment is, for example, an information processing apparatus such as a smartphone.

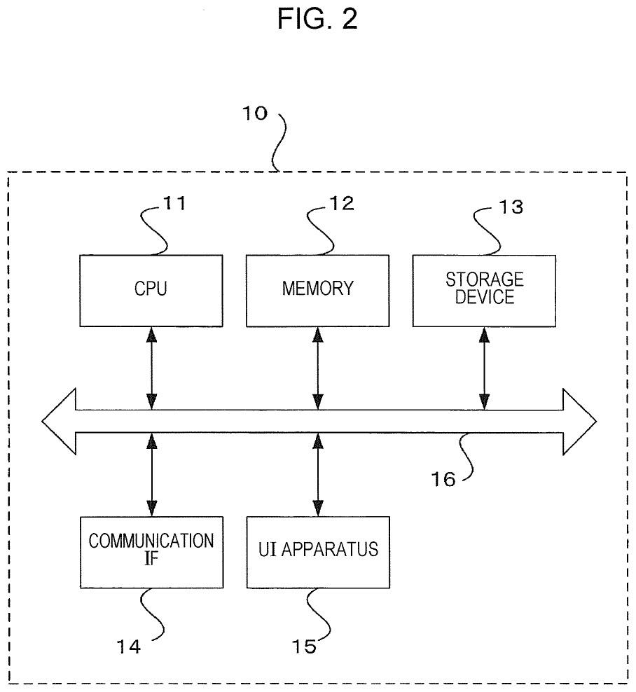

FIG. 2 illustrates the hardware configuration of the mobile terminal 10 in the information processing system according to the present exemplary embodiment.

As illustrates in FIG. 2, the mobile terminal 10 includes a central processing unit (CPU) 11, a memory 12, a storage device 13 such as a flash memory, a communication interface (IF) 14 which receives/transmits data from/to external apparatuses or the like over a public mobile phone network or the Internet 40, and a user interface (UI) apparatus 15 such as a touch panel. These components are connected to each other through a control bus 16.

The CPU 11 is a processor which performs predetermined processes on the basis of control programs stored in the memory 12 or the storage device 13 and which controls the operations of the mobile terminal 10. In the present exemplary embodiment, the CPU 11 is described as a component which reads, for execution, control programs stored in the memory 12 or the storage device 13. Alternatively, the programs may be stored in an external storage medium to be provided to the CPU 11.

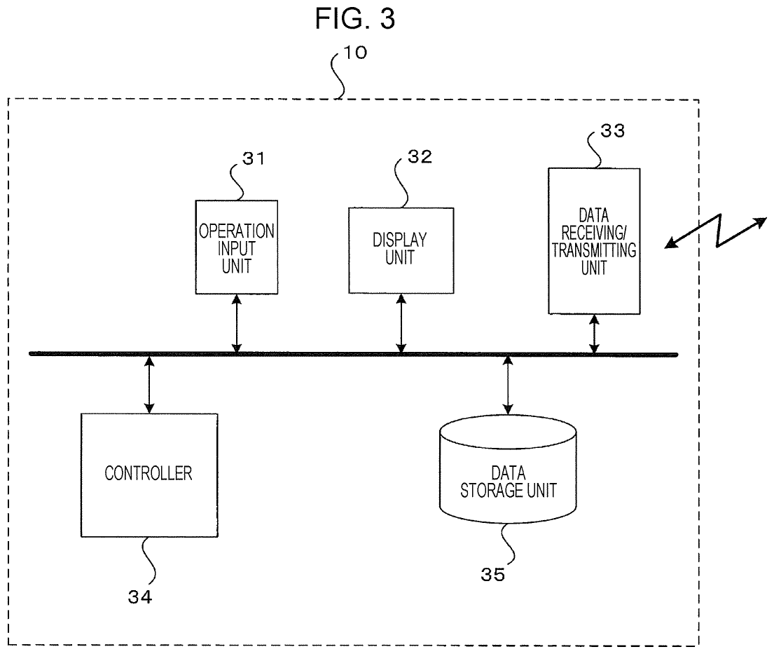

FIG. 3 is a block diagram illustrating the functional configuration of the mobile terminal 10 implemented through execution of the control programs.

As illustrated in FIG. 3, the mobile terminal 10 according to the present exemplary embodiment includes an operation input unit 31, a display unit 32, a data receiving/transmitting unit 33, a controller 34, and a data storage unit 35.

The operation input unit 31 receives information about various operations performed by a user. The display unit 32, which is controlled by the controller 34, displays various information to the user. The operation input unit 31 and the display unit 32 form a touch panel.

The data receiving/transmitting unit 34 receives/transmits data from/to external apparatuses such as the server apparatuses 20. The controller 34 controls the entire operation of the mobile terminal 10. The data storage unit 35 stores various data used when the controller 34 performs various processes.

In execution of various processes, the controller 34 controls the display unit 32 to display various operation screens to a user and receive various operations from the user. On such operation screens, display elements for receiving input about operations, such as menu screens and various setting screens, are displayed. In addition, messages for assisting user operations, such as guidance display describing functions, and prohibitive rules in setting functions, may be displayed as display elements. To notify a user of such a message, a banner image may be displayed so as to be superimposed on a display element for receiving a user operation.

However, a position at which the banner image is displayed on an operation screen may be often set in advance, for example, to the top end or the bottom end. Assume that a banner image is displayed on an operation screen at the display position of a display element for receiving input, such as a selection button, and is thus superimposed on the display element. Such a banner image causes a user not to be able to operate the display element for receiving input and perform various types of input.

In particular, assume the case in which a user is notified of some error notification and the like by using a banner image, and in which there is no way for the user to dismiss the banner image through the user's operation. In this case, the user is not able to input various operations until the error is resolved.

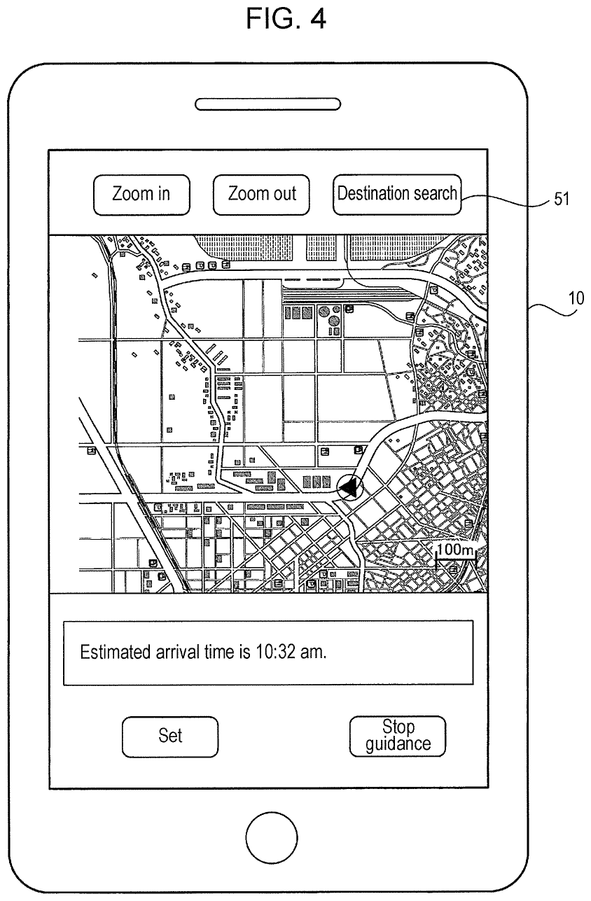

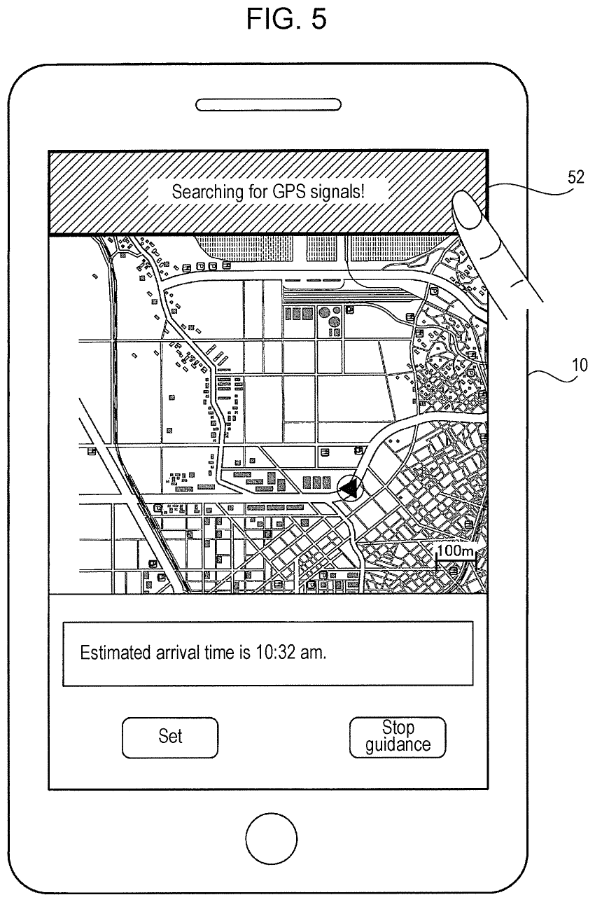

A concrete example provided when the controller 34 displays a banner image on the display unit 32 will be described by referring to FIGS. 4 and 5.

For example, the description will be made under the assumption that the operation screen illustrated in FIG. 4 is displayed on the display screen of the mobile terminal 10. The example in FIG. 4 illustrates an exemplary operation screen displayed when a navigation application program for guiding a user to a destination is invoked. Operation buttons 51 for destination search and the like are displayed on the operation screen.

FIG. 5 illustrates an example in which a banner image 52 is displayed on the operation screen. In the exemplary operation screen illustrated in FIG. 5, the banner image 52 for notifying a user of failure to receive GPS signals is displayed in a top end portion of the operation screen.

The banner image 52, which is thus displayed on the operation screen, covers the operation buttons 51 which have been displayed on the operation screen, causing the user not to be able to operate the operation buttons 51.

The banner image 52 is an image which is not dismissible through a user operation on the banner image 52. For example, the banner image 52 is an image which is dismissible by resolving the error which has occurred in the terminal apparatus 10 or a different apparatus. In the present exemplary embodiment, the banner image 52 is used to notify a user of an error indicating that GPS signals fail to be received. When GPS signals start to be received, the banner image 52 is dismissed automatically.

In the case where the banner image 52 continues to be displayed until GPS signals start to be received, the user is not able to operate the operation buttons 51 until the GPS signals start to be received.

Therefore, the mobile terminal 10 according to the present exemplary embodiment exerts control, which is described below, so as to enable the following operation. Even when the banner image 52 is displayed so as to be superimposed on the display area in which the image of the selectable operation buttons 51 and the like is displayed, the operation causes the image of the operation buttons 51 and the like to be recognized visually and selected with the banner image 52 being displayed.

Specifically, the image of the selectable operation buttons 51 and the like is displayed on the operation screen, and the banner image 52 is displayed in an area including the display area of the image of the operation buttons 51 and the like so that at least a part of the image of the operation buttons 51 and the like, on which the banner image 52 is superimposed, is not capable of being recognized visually. At that time, the controller 34 exerts control described below.

When the banner image 52 is displayed so that at least a part of the image of the operation buttons 51 and the like, on which the banner image 52 is superimposed, is not capable of being recognized visually, the controller 34 exerts control so as to receive an operation of enabling the image of the operation buttons 51 and the like to be recognized visually and selected with the banner image 52 being displayed in the area.

Specifically, when the banner image 52 is displayed so that at least a part of the image of the operation buttons 51 and the like, on which the banner image 52 is superimposed, is not capable of being recognized visually, the controller 34 exerts control to receive such an operation that the image of the operation buttons 51 and the like is moved so that the banner image 52 is not superimposed on the image of the operation buttons 51 and the like. That is, the image of the operation buttons 51 and the like has an original configuration in which the display position of the image is not moved through a user's operation. Regardless of this original configuration, control is exerted so that display of the banner image 52 superimposed on the image of the operation buttons 51 and the like causes the display position to be moved through a user's operation.

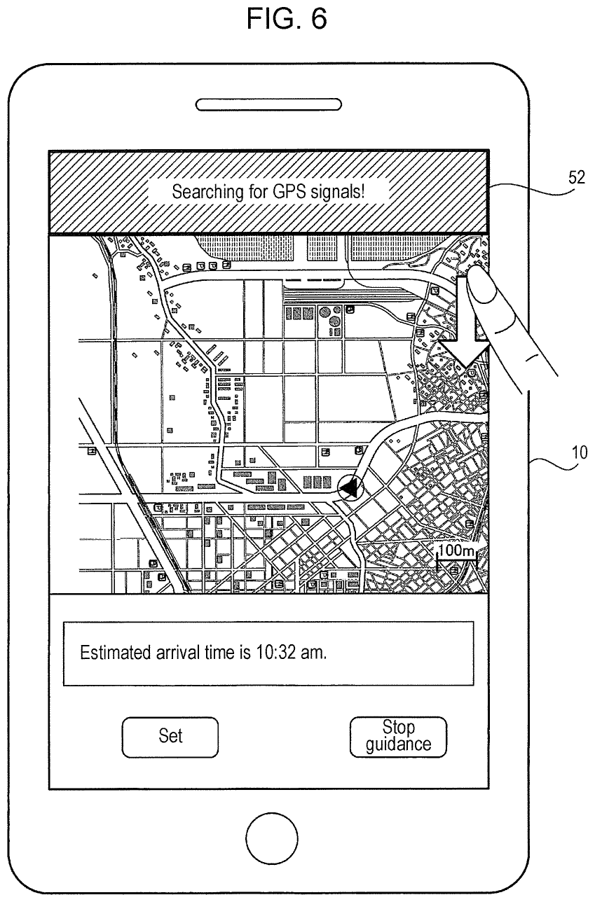

The state in which such control is exerted will be described by referring to FIGS. 6 to 8.

FIG. 6 illustrates the state in which a user taps an operation screen for scrolling, when the banner image 52 is displayed so as to cover the operation buttons 51.

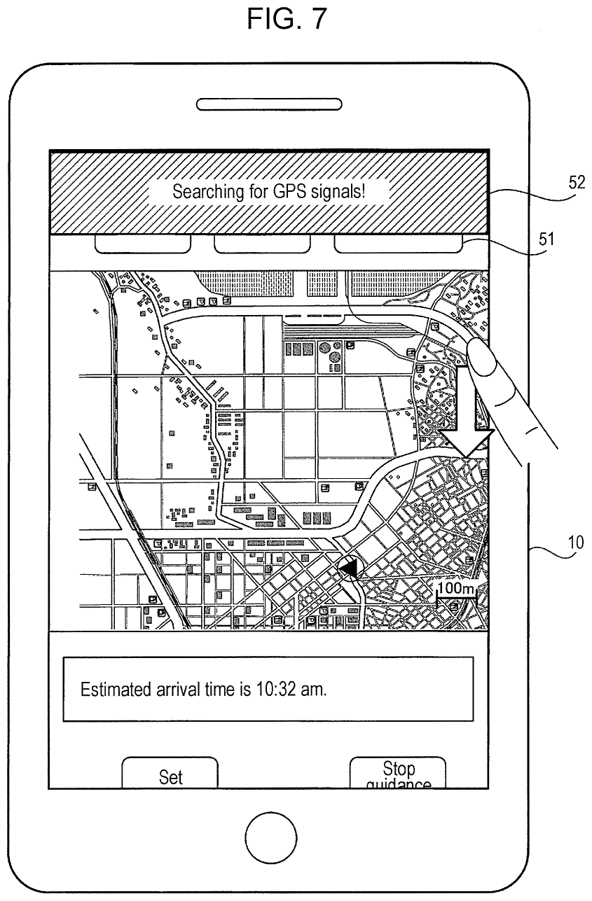

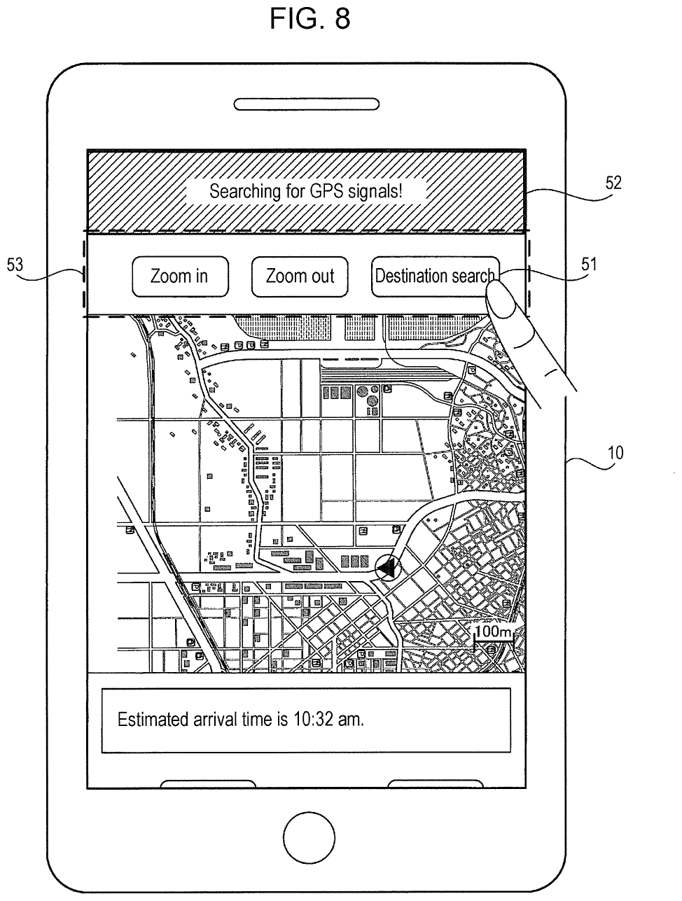

The user performs such a scroll operation. Thus, the entire operation screen, which has an original configuration in which the operation screen is not compatible with scroll display, moves as illustrated in FIG. 7. As a result, as illustrated in FIG. 8, the operation buttons 51 are moved to a position at which the banner image 52 is not superimposed on the operation buttons 51. Therefore, the user may recognize the operation buttons 51 visually and may operate the operation buttons 51 with the banner image 52 being displayed.

After the user performs a scroll operation to a position at which at least a part or the entirety of the operation buttons 51 may be recognized visually, even when the scroll operation is stopped, the display may remain on the operation screen in the state in which the operation buttons 51 are capable of being recognized visually. The operation buttons 51 may scroll to any position on the operation screen, for example, to a position which is below the position of the operation buttons 51 in FIG. 8. Alternatively, the display may remain in the state in which the operation buttons 51 are visually recognizable at the position at which the scrolling is stopped. After the operation buttons 51 scroll, the image of an operation button or the like which receives an operation for making the operation buttons 51 enter the visually unrecognizable state from the visually recognizable state may be displayed. The image may be displayed so as to be superimposed on an image 53 in an area including the operation buttons 51, or may be displayed at any position on the operation screen.

### Exemplary Embodiment using an Operation Screen having the Scroll Function

In the exemplary embodiment, the case in which a banner image is displayed on an operation screen, which does not have a scroll function originally, is described. A case in which a banner image is displayed on an operation screen having the scroll function will be described below.

In the present exemplary embodiment, the controller 34 moves list information, having multiple items, vertically or horizontally on the basis of a user's operation, and performs scroll display to display some items in the list information on the display area, as an image on the operation screen.

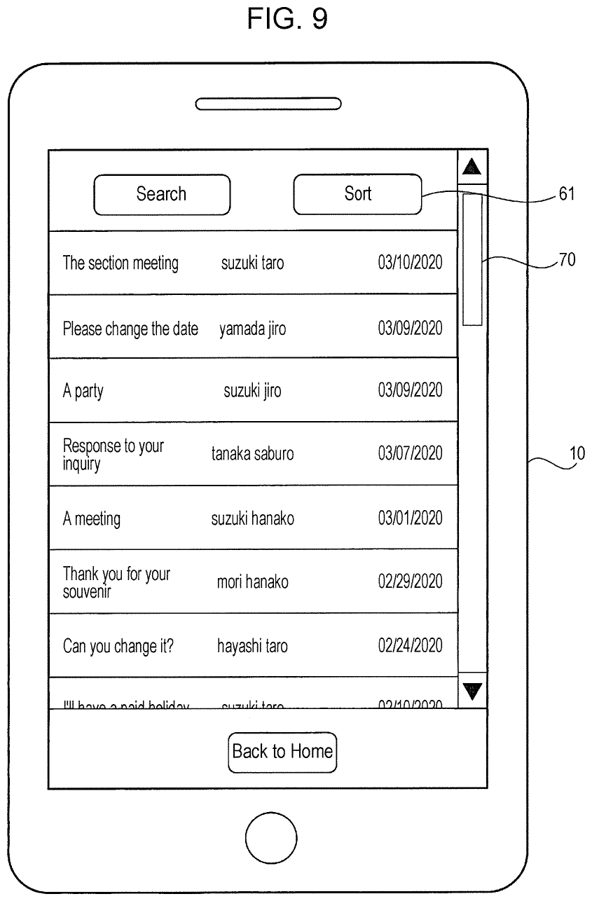

A concrete example performed by the controller 34 when a banner image is displayed on an operation screen having the scroll function will be described by referring to FIGS. 9 to 11.

The description will be made, for example, under the assumption that the operation screen as illustrated in FIG. 9 is displayed on the display screen of the mobile terminal 10. FIG. 9 is a diagram illustrating an exemplary operation screen having the scroll function. FIG. 9 illustrates an example in which an electronic-mail reception/transmission application program is invoked, and in which received electronic mails are displayed in a list on the exemplary operation screen. On the operation screen, in addition to list information of multiple received mails, operation buttons 61, such as a search button and a sort button, are displayed. In an end portion on the right of the operation screen, a scroll bar 70 is displayed. The scroll bar 70 indicates the position and the ratio, in the scroll range, of the image of the operation screen displayed in the display area.

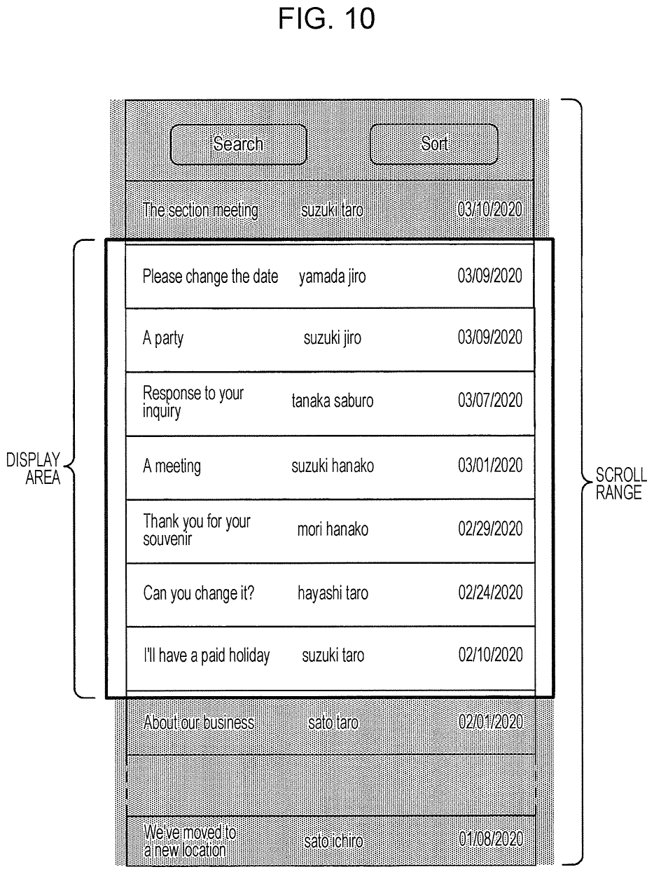

The relationship between the scroll range and the display area in the scroll display will be described by referring to FIG. 10.

FIG. 10 illustrates the state in which, in the case where information to be displayed needs a wider area than the display area assigned on the display screen, the entire information to be displayed is regarded as the scroll range and scroll display is performed. In the scroll display, the display area is moved in accordance with a scroll operation, and part of information which is included in the display area in the scroll range is displayed on the operation screen.

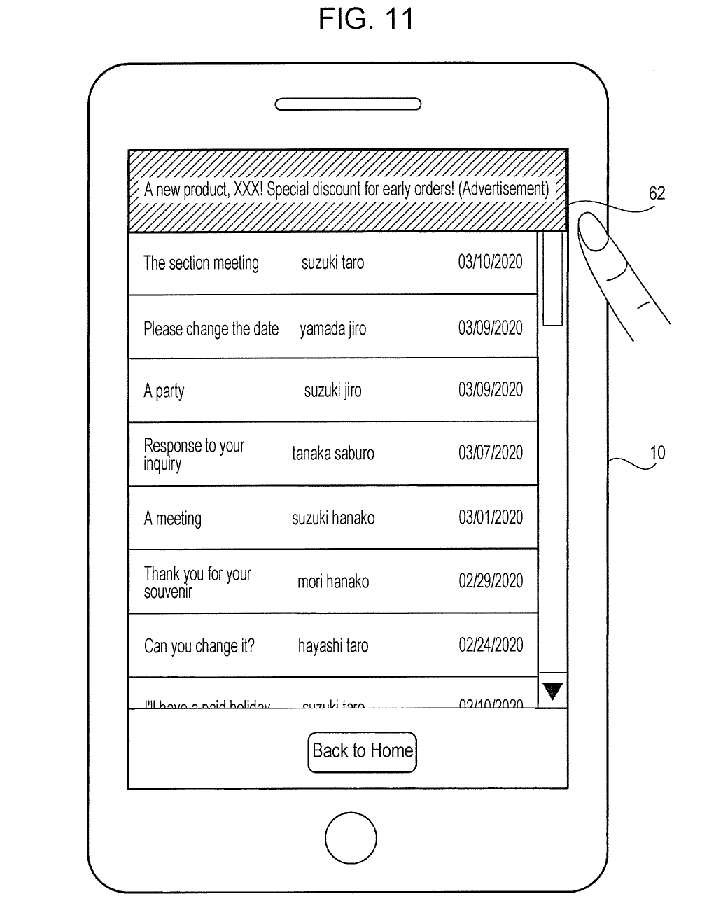

FIG. 11 illustrates an exemplary case in which a banner image 62 is displayed on the operation screen on which such scroll display is performed. On the exemplary operation screen illustrated in FIG. 11, the banner image 62 for notifying a user of advertisement information is displayed in a top end portion of the operation screen. In the present exemplary embodiment, the case in which a banner image is displayed so as to be superimposed in a top end portion of an operation screen which scrolls vertically will be described. The present disclosure may be applied similarly to the case in which a banner image is displayed so as to be superimposed in a bottom end portion. In the case of horizontal scrolling, the present disclosure may be applied similarly to the case in which a banner image is displayed so as to be superimposed in a left end portion or a right end portion of an operation screen.

When the banner image 62 is thus displayed on the operation screen, the operation buttons 61 which have been displayed on the operation screen are covered by the banner image 62, and a user is not able to operate the operation buttons 61.

In scroll display, the display content is moved due to the user's scroll operation. In the case where the banner image 62 is displayed at the top end of the operation screen, the banner image 62 is superimposed on the operation buttons 61 which are disposed at the top end of the scroll range even when the user scrolls down as much as possible.

In the present exemplary embodiment, assume the case in which a banner image is displayed so as to be superimposed in an end portion, in the scroll direction, of the display area. In this case, the controller 34 changes, in the scroll display, the scroll range of the image for the operation screen so that, even when the image on the operation screen is scrolled and the display area is moved to the end portion of the scroll range, the end portion area is displayed, not hidden by the banner image.

Specifically, when the banner image 62 is displayed so as to be superimposed in an end portion, in the scroll direction, of the image of the operation screen, the controller 34 adds an area, having the same length as the banner image 62, on side, on which the banner image 62 is displayed and superimposed, of the scroll range of the image of the operation screen. Thus, even when the image of the operation screen is scrolled and the display area is moved to an end portion of the scroll range, the area in the end portion is displayed, not hidden by the banner image 62.

That is, in the case where a reception button for receiving a user operation is included in the area in an end portion of the scroll range of the image of an operation screen, the controller 34 causes the reception button to be displayed, not to be hidden by the banner image 62, even when the image of the operation screen is scrolled and the display area is moved to the end portion of the scroll range.

The controller 34 displays the image of the operation screen, as well as the scroll bar indicating the position in the scroll range of the image of the operation screen displayed in the display area. Therefore, the controller 34 changes the display position of the scroll bar when the banner image 62 is displayed so as to be superimposed on the image of the operation screen.

The controller 34 shows the ratio, in the scroll range, of the image of the operation screen displayed in the display area, as the size of the scroll bar. Therefore, the controller 34 changes the size of the scroll bar when the banner image 62 is displayed so as to be superimposed on the image of the operation screen.

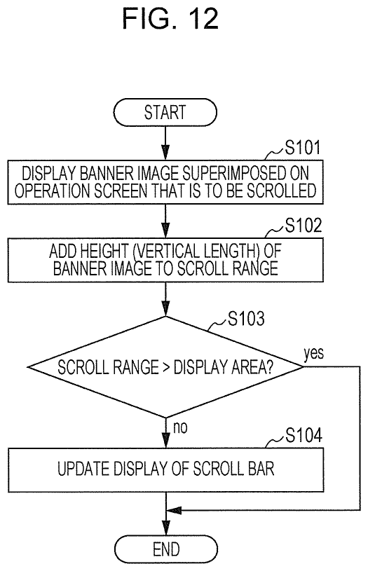

Operations performed by the controller 34 when the banner image 62 is displayed so as to be superimposed on the operation screen having the scroll function will be described by referring to the flowchart in FIG. 12.

In step S101, the controller 34 displays the banner image 62 so as to be superimposed on an operation screen on which scroll display is performed.

In step S102, the controller 34 adds the height, that is, the vertical length, of the banner image 62 to the scroll range.

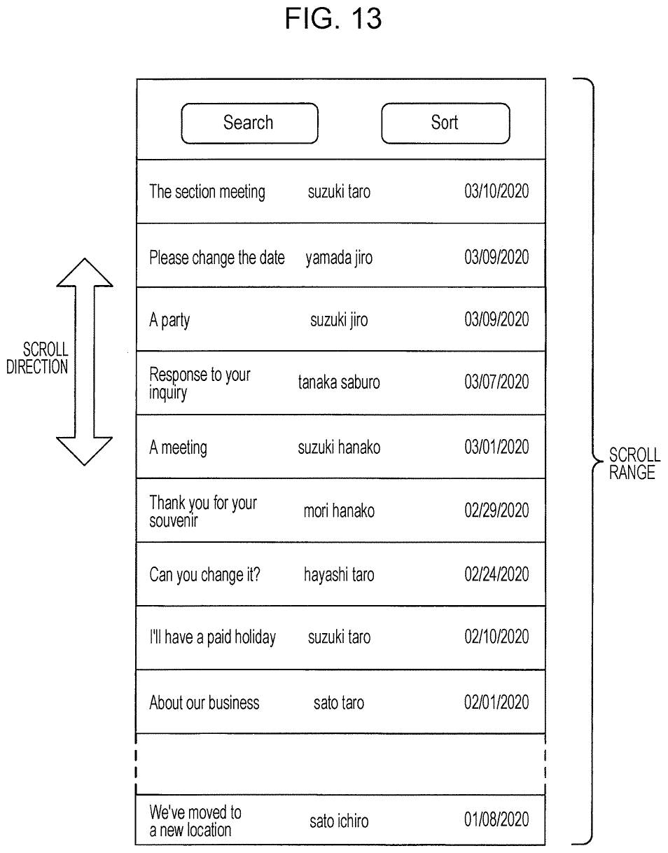

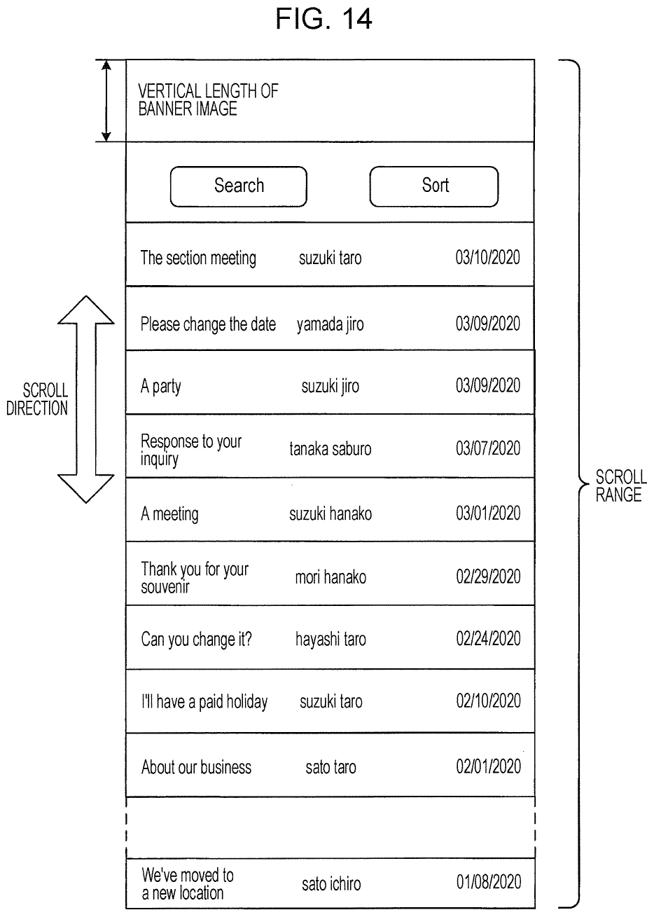

For example, in the case where the scroll range of the exemplary operation screen illustrated in FIG. 9 is the range illustrated in FIG. 13, the scroll range used when the banner image 62 is superimposed is the range illustrated in FIG. 14.

That is, it is seen that the scroll range used when the banner image 62 is superimposed is the range obtained by adding the vertical length of the banner image 62 to the scroll range illustrated in FIG. 13.

In step S103, the controller 34 determines whether or not the scroll range obtained after addition of the vertical length of the banner image 62 is larger than that of the display area.

If the scroll range is smaller than that of the display area, it is possible to display the entire display content in the original scroll range without scroll display. Thus, the scroll bar 70 does not need to be displayed.

If the scroll range is equal to or smaller than that of the display area, the controller 34 ends the process. If the scroll range is larger than that of the display area, the controller 34 updates display of the scroll bar 70 in step S104.

Even if the scroll range before addition of the vertical length of the banner image 62 to the scroll range is larger than that of the display area, the size of the scroll bar 70 needs to be changed due to the increase of the scroll range, and the display position of the scroll bar 70 needs to be changed due to the change of the current display position.

Therefore, even if the scroll range before addition of the vertical length of the banner image 62 to the scroll range is larger than that of the display area, display of the scroll bar 70 needs to be updated.

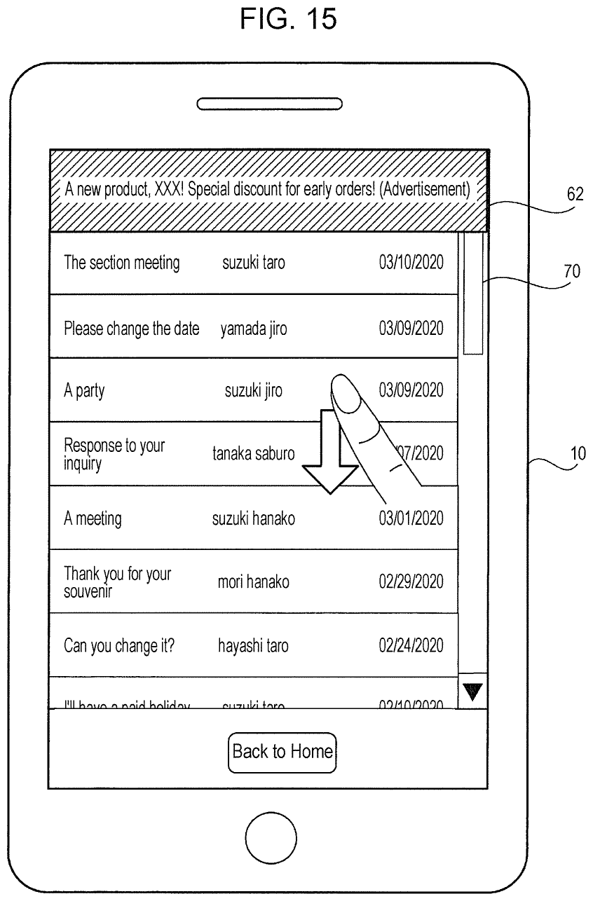

FIG. 15 illustrates an exemplary operation screen on the mobile terminal 10 for which the scroll range is thus changed. On the operation screen illustrated in FIG. 15, relative to the operation screen illustrated in FIG. 11, the size of the scroll bar 70 is made smaller and the display position has been moved downward.

The size of the scroll bar 70 is made smaller. The reason is that, since the size of the scroll bar 70 indicates the ratio of the display area to the entire scroll range, the length of the entire scroll range is larger by the vertical length of the banner image 62, and the size of the display area itself is not changed.

Display of the scroll bar 70 does not necessarily match the scrollable range. The size and the position of the scroll bar 70 do not necessarily match the ratio and the position, in the scroll range, of the display area. That is, even when the scroll bar 70 is located in the topmost portion, if the banner image 62 is displayed so as to be superimposed, scrolling may be performed downward farther by the vertical length of the banner image 62.

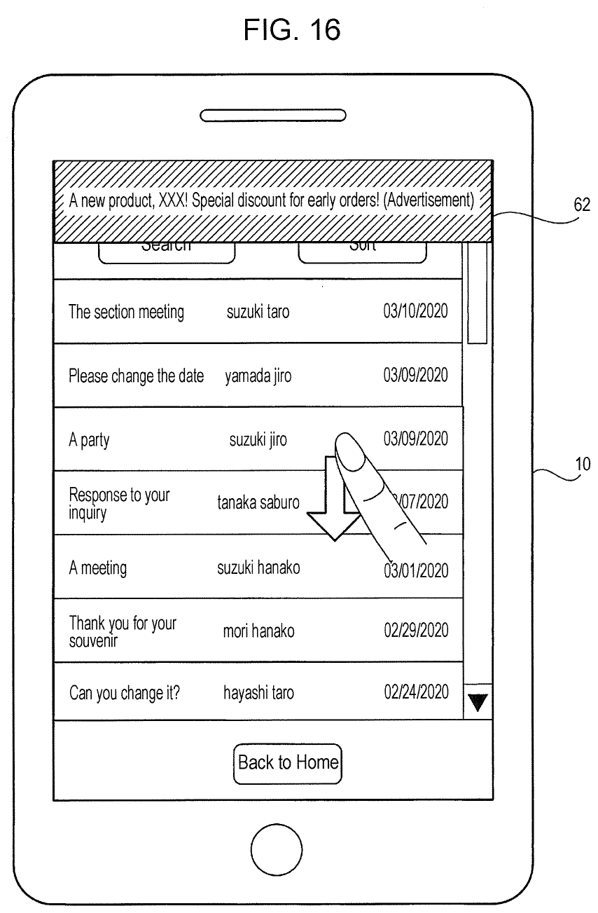

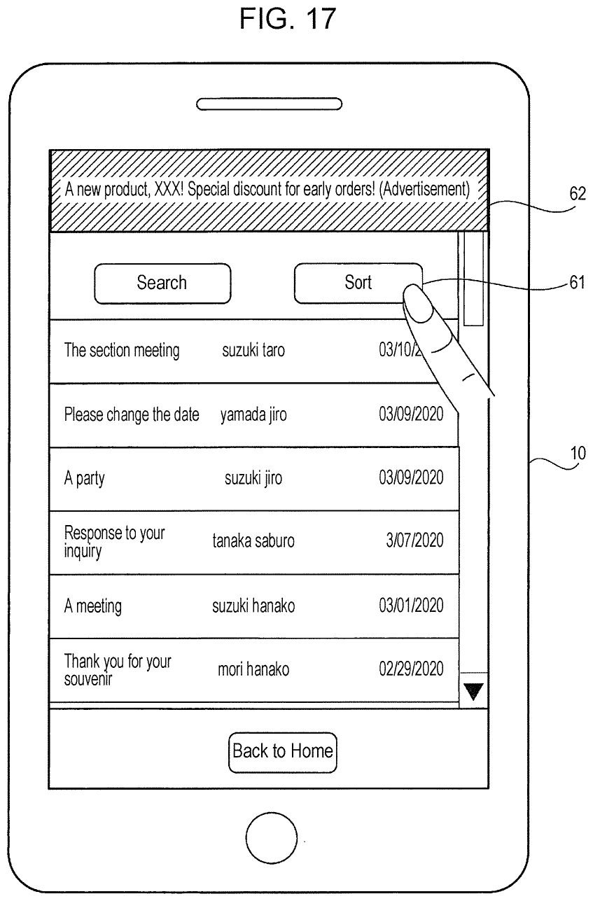

The scroll range has been thus changed. As illustrated in FIG. 15, when a user touches the operation screen to perform a scroll-down operation, the operation screen is moved further as illustrated in FIG. 16. As a result, as illustrated in FIG. 17, the operation buttons 61 are moved to a position at which the banner image 62 is not superimposed on the operation buttons 61. With the banner image 62 being displayed, the user may recognize the operation buttons 61 visually, and may operate the operation buttons 61.

FIGS. 15 to 17 are used to describe the case in which the operation screen is scrolled down further through a normal scroll operation called a flick operation. If a scroll operation is enabled in a wider range than a normal one by changing the scroll range, scroll display may be performed through an operation different from the normal operation.

For example, when a user continues to touch an operation screen for several seconds or more and the hold state is entered, a scroll operation may be enabled.

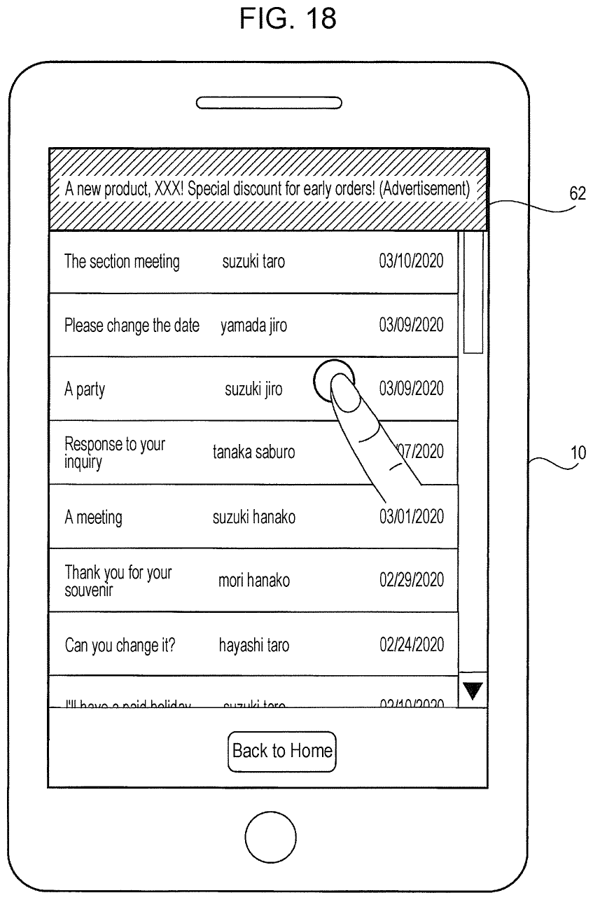

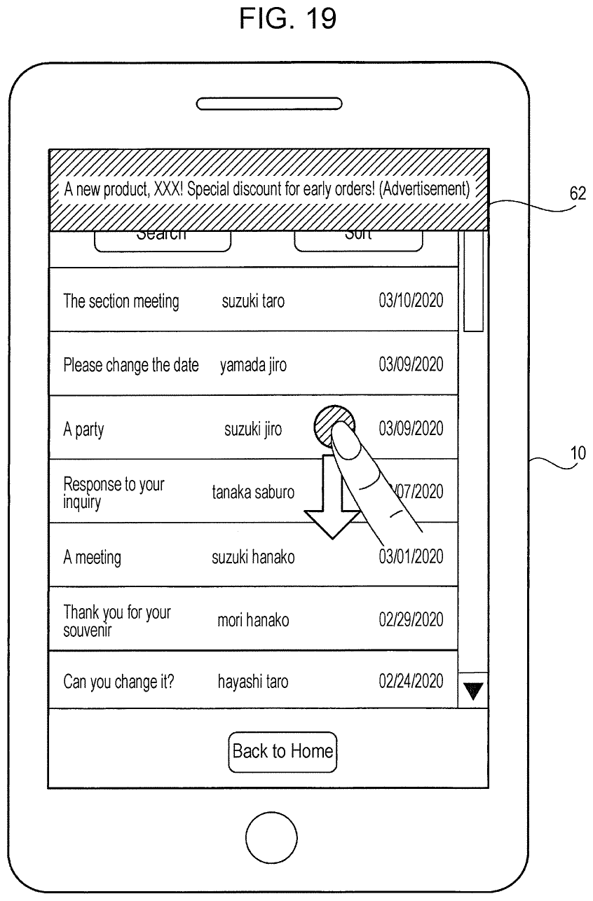

FIGS. 18 and 19 illustrate an exemplary operation performed when the hold state enables a scroll operation.

On the operation screen illustrated in FIG. 18, a normal scroll operation called a flick operation does not cause the screen to be scrolled. When a user keeps the tap state for a certain period or more and a transition to the hold state is made as illustrated in FIG. 19, a scroll operation is enabled.

In the exemplary embodiment described above, the banner image 62, which is displayed on the operation screen, causes the normal scroll range to be extended so that a display element, on which the banner image 62 is superimposed, may be moved to a position at which the banner image 62 does not cover the display element.

However, if there is dependence between multiple display elements displayed on the operation screen, such change of the normal scroll range may cause a problem.

Dependence between multiple display elements means the case in which an operation needs to be performed on a certain display element and a different display element collaboratively. That is, the dependence means that there is the following relationship: a certain display element is selected, and a different display element is then operated so that a specific process is performed.

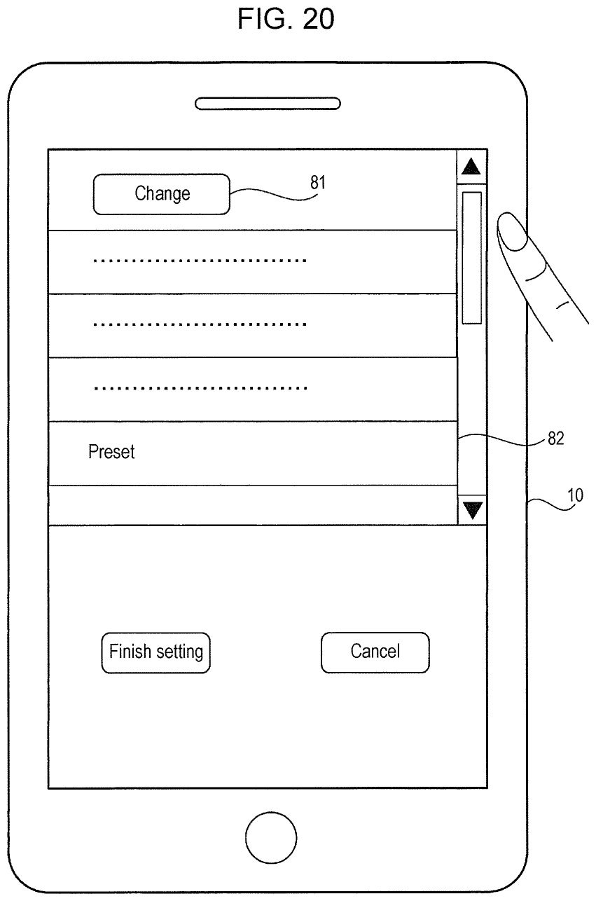

A concrete example of the case in which there is dependence between display elements will be described by referring to FIGS. 20 to 24.

The exemplary operation screen illustrated in FIG. 20 will be described under the assumption that there is dependence between a change button 81 and a preset button 82. Specifically, the preset button 82 is selected, and the change button 81 is then pressed so that an input process is started. Thus, the description will be made under the assumption that the change button 81 and the preset button 82 are operated collaboratively so that a specific process is performed.

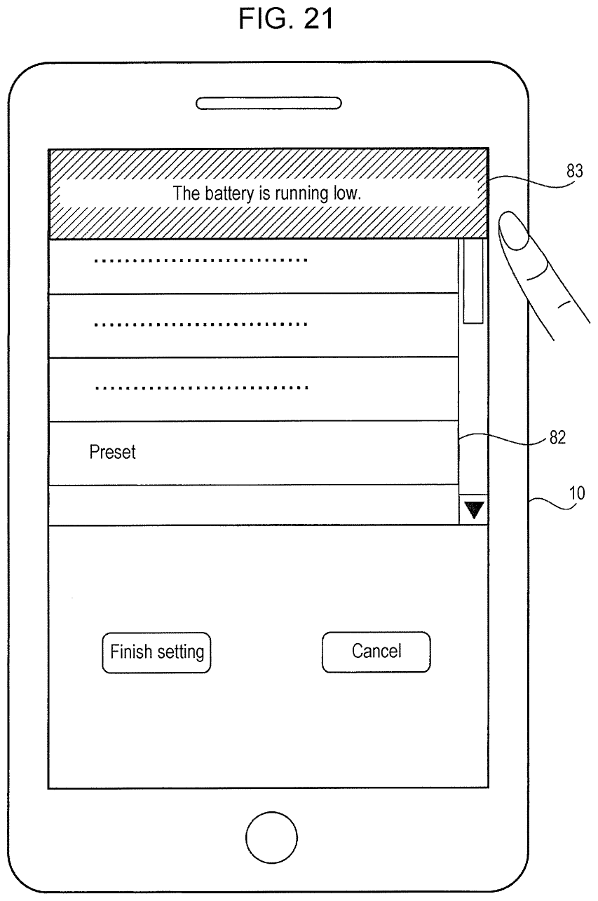

FIG. 21 illustrates the state in which a banner image 83 is displayed on the operation screen and the change button 81 is hidden. On the operation screen illustrated in FIG. 21, the banner image 83 is superimposed on the change button 81 which is not capable of being operated.

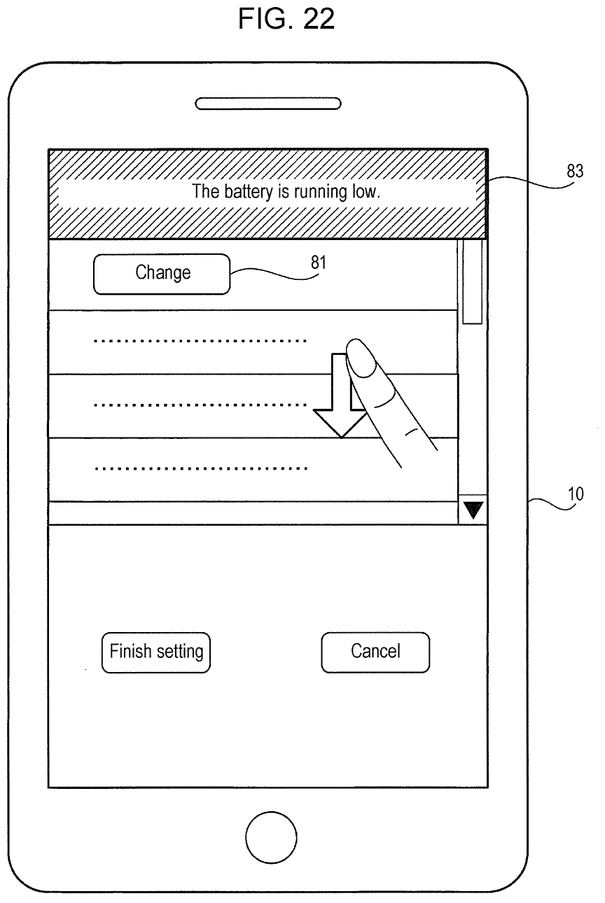

FIG. 22 illustrates an exemplary operation screen displayed when the scroll range is extended by the vertical length of the banner image 83 by using the method described above. On the exemplary operation screen illustrated in FIG. 22, the operation screen may be scrolled down further so that the change button 81 is moved to a position at which the change button 81 is not hidden by the banner image 83. However, the scroll operation of moving the change button 81 causes the preset button 82 to be located outside the display area and not to be displayed.

Two display elements, which have dependence, that is, the change button 81 and the preset button 82, are set as follows. The size of the display area and the positions of the change button 81 and the preset button 82 are set so that the change button 81 and the preset button 82 are always displayed at the same time. Regardless of this, a change of the scroll range may cause the state in which the change button 81 and the preset button 82 are not displayed at the same time.

If the two display elements which have dependence are not displayed at the same time, the visuality of a user operation decreases, and the operability degrades.

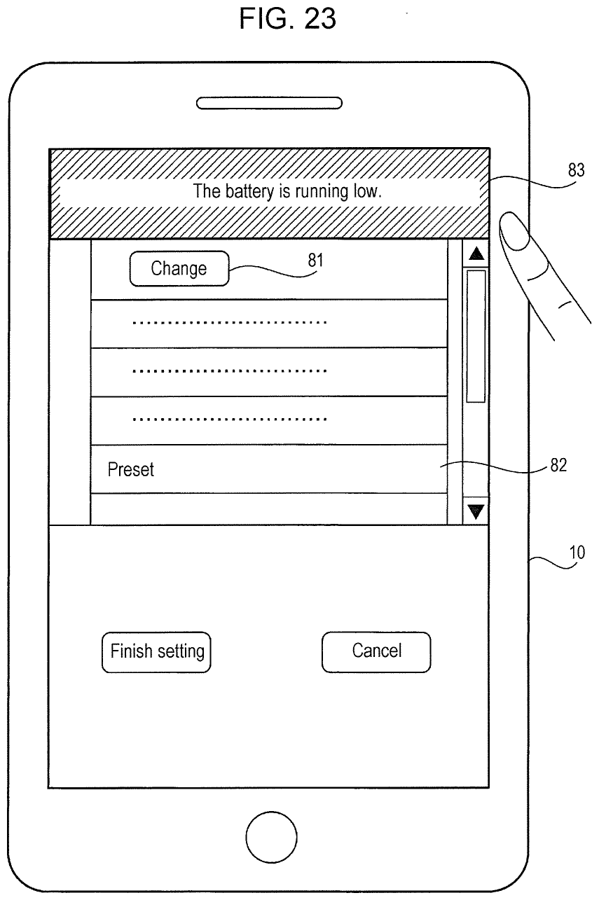

In the case where there is dependence between multiple display elements, when a change of the scroll range may cause the display elements not to be displayed at the same time, the display elements are reduced in size for display. Specifically, as illustrated in FIG. 23, each display element on the operation screen is reduced in size so that the preset button 82 remains in the display area even when the change button 81 is moved to a position at which the banner image 83 is not superimposed on the change button 81.

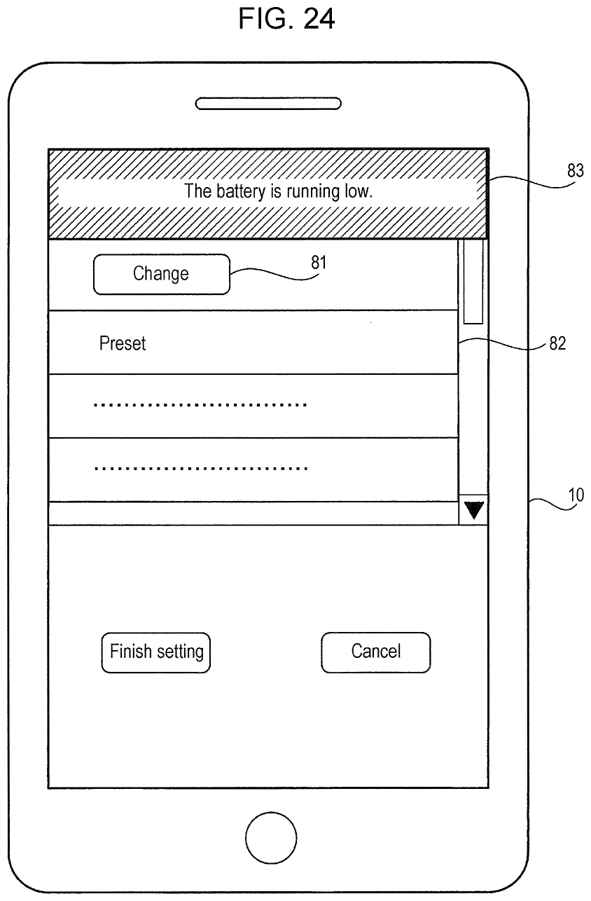

Alternatively, display elements may be rearranged and displayed so that the multiple display elements are not prevented from not being displayed at the same time. Specifically, when a change of the scroll range may cause the multiple display elements not to be displayed at the same time, the display position of the preset button 82 is changed as illustrated in FIG. 24. When the change button 81 is moved to a position at which the banner image 83 is not superimposed on the change button 81, the preset button 82 remains in the display area.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Modified Example

In the exemplary embodiment described above, the case in which a banner image is displayed on an operation screen of a mobile terminal such as a smartphone is described. The present disclosure is not limited to this. Similarly, the present disclosure may be applied to the case in which notification images such as banner images are displayed so as to be superimposed on the operation screens of various information processing apparatuses, such as an image forming apparatus and a personal computer.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
display a first, selectable image at first position on a display,
display a second image over at least part of the first image so as to hide the at least part of the first image, and,
when the second image is displayed over the at least part of the first image, exert control so as to receive an operation for making the first image visible and selectable while continuing to display the second image at the first position.

2. The information processing apparatus according to claim 1,
wherein the second image is not dismissible by a user operation on the second image.

3. The information processing apparatus according to claim 2,
wherein the second image is dismissible by resolving an error occurring in the information processing apparatus or a different apparatus.

4. The information processing apparatus according to claim 1,
wherein, when the second image is displayed over the at least part of the first image, the processor is configured to receive an operation of moving the first image to avoid an overlap with the second image.

5. The information processing apparatus according to claim 2,
wherein, when the second image is displayed over the at least part of the first image, the processor is configured to receive an operation of moving the first image to avoid an overlap with the second image.

6. The information processing apparatus according to claim 3,
wherein, when the second image is displayed over the at least part of the first image, the processor is configured to receive an operation of moving the first image to avoid an overlap with the second image.

7. The information processing apparatus according to claim 1,
wherein, in a case where a list having a plurality of items is moved vertically or horizontally on a basis of a user operation so that a subset of the items in the list is displayed as the first image on a display area, when the second image is displayed at an edge of the display area in a scroll direction, even when the first image is scrolled and the display area is moved to an end portion of a scroll range, the processor is configured to change the scroll range of the first image in such a manner that an area in the end portion of the scroll range is displayed without being hidden by the second image.

8. The information processing apparatus according to claim 7,
wherein, in a case where the second image is displayed over an end portion of the first image, the end portion being located in the scroll direction, even when the first image is scrolled and the display area is moved to the end portion of the scroll range, the processor is configured to add an area on a side of the scroll range of the first image, the added area having a height substantially equal to a height of the second image, the side being a side on which the second image is displayed so as to be superimposed, and thus display an area in the end portion of the scroll range in such a manner that the area is displayed without being hidden by the second image.

9. The information processing apparatus according to claim 8,
wherein an area in the end portion of the scroll range of the first image includes a reception button for receiving a user operation, and
wherein, even when the first image is scrolled and the display area is moved to the end portion of the scroll range, the reception button is displayed without being hidden by the second image.

10. The information processing apparatus according to claim 7,
wherein the processor is configured to display, on the display, the first image as well as a scroll bar which indicates a position of a part of the first image in the scroll range, the part of the first image being displayed in the display area, and
wherein, when the second image is displayed over the first image, the processor is configured to change a display position of the scroll bar.

11. The information processing apparatus according to claim 8,
wherein the processor is configured to display, on the display, the first image as well as a scroll bar which indicates a position of a part of the first image in the scroll range, the part of the first image being displayed in the display area, and
wherein, when the second image is displayed over the first image, the processor is configured to change a display position of the scroll bar.

12. The information processing apparatus according to claim 9,
wherein the processor is configured to display, on the display, the first image as well as a scroll bar which indicates a position of a part of the first image in the scroll range, the part of the first image being displayed in the display area, and
wherein, when the second image is displayed over the first image, the processor is configured to change a display position of the scroll bar.

13. The information processing apparatus according to claim 10,
wherein the processor is configured to illustrate a ratio of a part of the first image with respect to the scroll range by using a size of the scroll bar, the part of the first image being displayed in the display area, and
wherein, when the second image is displayed over the first image, the processor is configured to change the size of the scroll bar.

14. The information processing apparatus according to claim 11,
wherein the processor is configured to illustrate a ratio of a part of the first image with respect to the scroll range by using a size of the scroll bar, the part of the first image being displayed in the display area, and
wherein, when the second image is displayed over the first image, the processor is configured to change the size of the scroll bar.

15. The information processing apparatus according to claim 12,
wherein the processor is configured to illustrate a ratio of a part of the first image with respect to the scroll range by using a size of the scroll bar, the part of the first image being displayed in the display area, and
wherein, when the second image is displayed over the first image, the processor is configured to change the size of the scroll bar.

16. A non-transitory computer readable medium storing a program causing a computer to execute a process comprising:
displaying a first, selectable image at first position on a display;
displaying a second image over at least part of the first image so as to hide the at least part of the first image; and,
when the second image is displayed over the at least part of the first image, exerting control so as to receive an operation for making the first image visible and selectable while continuing to display the second image at the first position.

17. An information processing apparatus comprising:
means for displaying a first, selectable image at first position on a display;
means for displaying a second image over at least part of the first image so as to hide the at least part of the first image; and
means for, when the second image is displayed over the at least part of the first image, exerting control so as to receive an operation for making the first image visible and selectable while continuing to display the second image at the first position.
